(19) United States
(12) Patent Application Publication
(10) Pub. No.: US 2020/0351710 A1
(43) Pub. Date: Nov. 5, 2020

(54) DATA PROCESSING METHOD, APPARATUS AND SYSTEM, MOBILE DEVICE, AND STORAGE MEDIUM

(71) Applicant: SZ DJI TECHNOLOGY CO., LTD., Shenzhen (CN)

(72) Inventors: Guangyuan LIN, Shenzhen (CN); Zhendong WANG, Shenzhen (CN); Wenjun WANG, Shenzhen (CN)

(21) Appl. No.: 16/931,259

(22) Filed: Jul. 16, 2020

Related U.S. Application Data
(63) Continuation of application No. PCT/CN2018/073451, filed on Jan. 19, 2018.

(51) Int. Cl. H04W 28/06; H04L 12/741; H04L 29/08

(52) U.S. Cl. CPC H04W 28/06; H04L 67/26; H04L 45/74

(57) ABSTRACT

A data processing method includes, in response to detecting that a target data packet needs to be sent, obtaining subscription information configured for the target data packet, determining one or more user identifications (IDs) recorded in the subscription information according to the subscription information, and pushing the target data packet according to the one or more user IDs.

### CROSS-REFERENCE TO RELATED APPLICATION

This application is a continuation of International Application No. PCT/CN2018/073451, filed on Jan. 19, 2018, the entire content of which is incorporated herein by reference.

### TECHNICAL FIELD

The present disclosure relates to the technical field of control and, more particularly, to a data processing method, apparatus, and system, a mobile device, and a storage medium.

### BACKGROUND

With the development of computer technologies, smart terminal devices such as unmanned aerial vehicles (UAVs) and gimbals are gradually popularized. The terminal devices store data generated in operation processes and send the stored data to apparatuses or devices when needed.

However, when the terminal device storing data receives many data requests from various terminal devices, a communication load of the terminal device storing data is too large, and even exceeds a load capacity of the terminal device.

### SUMMARY

In accordance with the disclosure, there is provided a data processing method including, in response to detecting that a target data packet needs to be sent, obtaining subscription information configured for the target data packet, determining one or more user identifications (IDs) recorded in the subscription information according to the subscription information, and pushing the target data packet according to the one or more user IDs.

Also in accordance with the disclosure, there is provided a data processing apparatus including a memory storing program instructions and a processor configured to call the program instructions to, in response to detecting that a target data packet needs to be sent, obtain subscription information configured for the target data packet, determine one or more user identifications (IDs) recorded in the subscription information according to the subscription information, and push the target data packet according to the one or more user IDs.

Also in accordance with the disclosure, there is provided a mobile device including a data apparatus configured to, in response to detecting that a target data packet needs to be sent, obtain subscription information configured for the target data packet, determine one or more user identifications (IDs) recorded in the subscription information according to the subscription information, and push the target data packet according to the one or more user IDs.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples and other drawings conceived by those having ordinary skills in the art on the basis of the described drawings without inventive efforts should fall within the scope of the present disclosure.

FIG. 1 is a schematic flowchart of an interaction process of a data processing method consistent with embodiments of the disclosure.

FIG. 2 is a schematic flow chart of a data processing method consistent with embodiments of the disclosure.

FIG. 3 is a schematic flow chart of another data processing method consistent with embodiments of the disclosure.

FIG. 4 is a schematic structural diagram of a data processing apparatus consistent with embodiments of the disclosure.

FIG. 5 is a schematic structural diagram of a mobile device consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Hereinafter, the example embodiments will be described with reference to the accompanying drawings. Unless conflicting, the exemplary embodiments and features in the exemplary embodiments can be combined with each other.

The present disclosure provides a data processing method that can be applied to a data processing system, and the data processing system can include a data processing apparatus and a requesting apparatus(es). The data processing apparatus may include any kind of mobile device, for example, an unmanned aerial vehicle (UAV), a gimbal mounted at a UAV, an unmanned car, a robot, or the like. The requesting apparatus(es) may be a part of the data processing apparatus, or may include a flight controller connected to the mobile device (e.g., the UAV) or any other device connected to the mobile device. The data processing method consistent with the present disclosure will be described below. The data processing method described below can be applied to the UAV, the gimbal, an unmanned vehicle, or another mobile device.

In some embodiments, the data processing apparatus can obtain subscription information configured for a target data packet in response to detecting that the target data packet needs to be sent. According to the subscription information, a user identification(s) (ID) recorded in the subscription information can be determined from the subscription information, and the target data packet can be pushed to the requesting apparatus(es) indicated by the user ID(s) according to the determined user ID(s).

In some embodiments, the requesting apparatus of the data processing system may send a subscription request for subscribing to the target data packet to the data processing apparatus. The subscription request can carry the user ID of the requesting apparatus. The target data packet can include data information stored in the data processing apparatus. For example, assume that the data processing apparatus is arranged at the UAV, then the target data packet may include data, e.g., attitude information and/or position information, captured by the UAV. The attitude information may include, for example, one or more of a movement angle, a speed, an acceleration, and the like, of the UAV, and the position information may include Global Positioning System (GPS) information or the like. As another example, assume that the data processing apparatus is arranged at the gimbal mounted at the UAV, then the target data packet may include data, e.g., attitude information and/or position information, captured by the gimbal. The attitude information may include, for example, one or more of a pitch angle, a yaw angle, a roll angle, a speed, an acceleration, and the like, of the gimbal, and the position information may include, for example, GPS information or the like.

In some embodiments, when receiving the subscription request sent by the requesting apparatus for subscribing to the target data packet, the data processing apparatus may determine the user ID of the requesting apparatus from the subscription request and record the user ID in the subscription information configured for the target data packet.

In some embodiments, the data processing apparatus may detect whether the user ID exists in the subscription information before recording the user ID in the subscription information configured for the target data packet. If the user ID does not exist, the user ID can be recorded in the subscription information configured for the target data packet.

In some embodiments, the requesting apparatus can send the subscription request for subscribing to the target data packet to the data processing apparatus using the user ID assigned for itself, and set a task-pushed-times threshold in a subscription protocol. The task-pushed-times threshold can refer to the number of times the target data packet to be pushed that is limited by the data processing apparatus. The subscription protocol can be included in the subscription information, such that the subscription information can include the task-pushed-times threshold in the subscription protocol. Before pushing the target data packet, the data processing apparatus may detect whether the number of times the target data packet has been pushed is less than the task-pushed-times threshold in the subscription information. If a detection result shows that the number of times the target data packet has been pushed is less than the task-pushed-times threshold (e.g., the detection result is “less than” or “yes”), the target data packet can be pushed to the requesting apparatus indicated by the user ID according to the determined user ID.

In some embodiments, routing information can be bounded to the user ID. When pushing the target data packet to the requesting apparatus who has sent the subscription request, the data processing apparatus may obtain the user ID from the received subscription request by querying a route, and obtain the routing information bounded to the user ID. According to the routing information, the data processing apparatus can determine a physical port corresponding to the routing information to push the target data packet to the requesting apparatus indicated by the user ID through the physical port corresponding to the routing information.

In some embodiments, before pushing the target data packet to the requesting apparatus indicated by the user ID, the data processing apparatus may detect whether the number of the user ID(s) recorded in the subscription information is equal to zero. If it is not equal to zero, the user ID recorded in the subscription information can be determined according to the subscription information.

In some embodiments, the data processing apparatus can include a pushed-ID counter for counting the number of user ID(s) to which the target data packet has been pushed. The data processing apparatus may determine a target user ID from the user ID(s), and push the target data packet to the requesting apparatus corresponding to the target user ID. When pushing the target data packet according to the target user ID, each time the target data packet is pushed to the requesting apparatus corresponding to the target user ID, a count number of the pushed-ID counter can be increased by one. The target user ID can be determined according to an order of the user ID(s) in a subscription list of the subscription information.

In some embodiments, after pushing the target data packet to the requesting apparatus indicated by the user ID according to the determined user ID, the data processing apparatus may detect whether the number of user ID(s), to which the target data packet has been pushed, recorded in the pushed-ID counter is equal to the number of user IDs recorded in the subscription information. If they are not equal, determining the user ID recorded in the subscription information according to the subscription information can be triggered again after delaying for a preset time interval. If they are equal, the data processing apparatus can stop pushing the target data packet. As such, a challenge of sudden data on system stability can be effectively avoided and a communication load of the system can be reduced.

The data processing method consistent with the present disclosure can be applied to data processing tasks of the mobile device, e.g., a robot that can move autonomously. Hereinafter, the data processing method for the mobile device will be described with reference to the accompanying drawings.

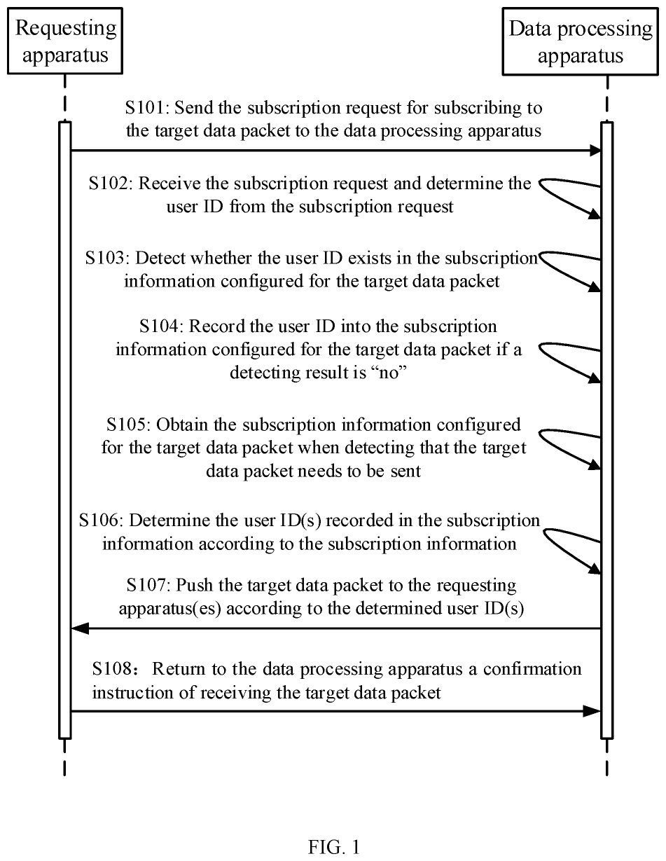

FIG. 1 is a schematic flowchart of an interaction process of an example data processing method consistent with the disclosure. The method can be applied to a data processing system, for example, the data processing system described above.

As shown in FIG. 1, at S101, the requesting apparatus sends the subscription request for subscribing to the target data packet to the data processing apparatus. The requesting apparatus may send the subscription request for subscribing to the target data packet to the data processing apparatus, and the subscription request can carry the user ID configured by the requesting apparatus itself. The user ID carried in the subscription request is also referred to as a “requesting user ID.”

At S102, the data processing apparatus receives the subscription request and determines the user ID from the subscription request. The data processing apparatus can receive the subscription request and determine the user ID from the subscription request. For example, assume that the user ID is a numerical digit 1, the data processing apparatus may determine that the user ID of the requesting apparatus is 1 from the subscription request when receiving the subscription request sent by the requesting apparatus.

At S103, the data processing apparatus detects whether the user ID exists in the subscription information configured for the target data packet. After determining the user ID of the requesting apparatus from the subscription request, the data processing apparatus may detect whether the user ID exists in the subscription information configured for the target data packet. The subscription information can include the subscription list of user ID requesting to subscribe to the target data packet.

At S104, if the detecting result is the user ID does not exist in the subscription information (e.g., the detecting result is “no”), the data processing apparatus records the user ID in the subscription information configured for the target data packet. A user ID not existing in the subscription information is also referred to as a “non-existing user ID.” If detecting that the user ID determined from the subscription request does not exist in the subscription information, the data processing apparatus may record the user ID to the subscription list of subscription information configured for the target data packet.

In some embodiments, the data processing apparatus may obtain time information of each received subscription request for subscribing to the target data packet, and record the user ID determined from each subscription request in the subscription information configured for the target data packet according to a sequence of time information (also referred to as “time sequence”). For example, assume that the data processing apparatus receives the subscription requests sent by three requesting apparatuses for subscribing to the target data packet. When receiving the subscription requests, the data processing apparatus may obtain that the time for receiving the subscription request from a first requesting apparatus is 9:00, the time for receiving the subscription request from a second requesting apparatus is 9:05, and the time for receiving the subscription request from a third requesting apparatus is 9:10. According to the time sequence of the subscription requests of the requesting apparatuses, the data processing apparatus may sequentially record user ID 1 determined from the subscription request of the first requesting apparatus, user ID 2 determined from the subscription request of the second requesting apparatus, and user ID 3 determined from the subscription request of the third requesting apparatus into the subscription information configured for the target data packet.

At S105, the data processing apparatus obtains the subscription information configured for the target data packet in response to detecting that the target data packet needs to be sent. When detecting that the target data packet needs to be sent, the data processing apparatus may obtain the subscription information configured for the target data packet, and obtain the subscription list subscribed to the target data packet from the subscription information. The subscription list can store the user ID(s) of the requesting apparatus(es) that subscribes to the target data packet.

At S106, the data processing apparatus determines the user ID(s) recorded in the subscription information according to the subscription information. The data processing apparatus can determine the user ID(s) recorded in the subscription list of the subscription information according to the subscription information. For example, the data processing apparatus may determine, according to the subscription information, that the user IDs recorded in the subscription list of the subscription information are 1, 2, 3 in the time sequence.

At S107, the data processing apparatus pushes the target data packet to the requesting apparatus(es) according to the determined user ID(s). The data processing apparatus may push the target data packet to the requesting apparatus(es) indicated by the user ID(s) according to the user ID(s) determined in the subscription information. For example, if the user IDs in the subscription list of the subscription information determined by the data processing apparatus are 1, 2, 3 in the time sequence, the data processing apparatus may sequentially push the target data packet to the first requesting apparatus indicated by user ID 1, the second requesting apparatus indicated by user ID 2, and the third requesting apparatus indicated by user ID 3.

In some embodiments, the subscription information configured for the target data packet can further include the task-pushed-times threshold, and the task-pushed-times threshold can refer to the number of times the target data packet to be pushed that is limited by the data processing apparatus. Before pushing the target data packet to the requesting apparatus(es) indicated by the user ID(s), the data processing apparatus may detect whether the number of times the target data packet has been pushed (also referred to as “packet-pushed times”) is less than the task-pushed-times threshold. If the detection result is “less than,” the data processing apparatus may push the target data packet to the requesting apparatus(es) indicated by the user ID(s) sequentially according to the user ID(s) determined in the subscription list of the subscription information and the order of the user ID(s) in the subscription list.

In some embodiments, the routing information can be bounded to the user ID. When pushing the target data packet according to the determined user ID(s), the data processing apparatus can obtain the routing information bounded to the user ID(s) according to the user ID(s), and according to the routing information, determine the physical port(s) corresponding to the routing information to push the target data packet to the requesting apparatus(es) indicated by the user ID(s) through the physical port(s) corresponding to the routing information.

In some embodiments, after pushing the target data packet to the requesting apparatus(es) indicated by the user ID(s) according to the determined user ID(s), the data processing apparatus may detect whether the number of user IDs, to which the target data packet has been pushed, recorded in the pushed-ID counter is equal to the number of user IDs recorded in the subscription information and, if it is not equal, determine the user ID(s) recorded in the subscription information according to the subscription information can be triggered again after delaying for the preset time interval. If it is detected that the count number in the pushed-ID counter is equal to the number of user IDs recorded in the subscription information, the data processing apparatus can stop pushing the target data packet. For example, assume that the preset time interval set by the data processing apparatus is 2 s and the user IDs in the subscription list of the subscription information are 1, 2, 3 in order, then if it is detected that the number of user IDs, to which the target data packet has been pushed, and which is recorded in the pushed-ID counter, is not equal to the number of user IDs recorded in the subscription information, then after a delay of 2 s (i.e., the preset time interval), the data processing apparatus can be triggered again to determine user ID 2 that is recorded after user ID 1 in the subscription information according to the subscription information, and send the target data packet to the requesting apparatus indicated by user ID 2. The processes described above can be repeated in sequence until, after the target data packet is sent to the requesting apparatus indicated by user ID 3, the number of user IDs, to which the target data packet has been pushed, recorded in the pushed-ID counter is detected to be equal to the number of user IDs recorded in the subscription information, then the data processing apparatus can stop pushing the target data packet.

At S108, the requesting apparatus returns to the data processing apparatus a confirmation instruction of receiving the target data packet. After receiving the target data packet pushed by the data processing apparatus, the requesting apparatus may send the confirmation instruction to the data processing apparatus to notify the data processing apparatus that the requesting apparatus has received the target data packet.

Consistent with the disclosure, the subscription request for subscribing to the target data packet can be sent to the data processing apparatus by the requesting apparatus, and the data processing apparatus can record the user ID carried in the subscription request in the subscription information configured for the target data packet. When detecting that the target data packet needs to be sent, the data processing apparatus can obtain the subscription information configured for the target data packet, and determine the user ID(s) recorded in the subscription information according to the subscription information. Therefore, the target data packet can be pushed according to the determined user ID(s). As such, different data push needs can be compatible, the communication load of the system can be effectively balanced, and the system stability can be improved.

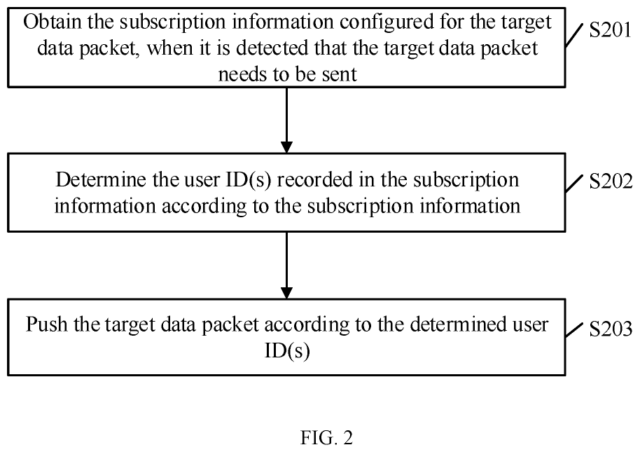

FIG. 2 is a schematic flow chart of an example data processing method consistent with the disclosure. The method can be applied to a data processing apparatus, for example, the data processing apparatus described above.

As shown in FIG. 2, at S201, when it is detected that the target data packet needs to be sent, the subscription information configured for the target data packet is obtained. When detecting that the target data packet needs to be sent, the data processing apparatus may obtain the subscription information configured for the target data packet. The subscription information can include the subscription list, and the subscription list can store the user ID(s) of the requesting apparatus(es) requesting the target data packet.

At S202, the user ID(s) recorded in the subscription information is determined according to the subscription information. After detecting that the target data packet needs to be sent, the data processing apparatus may determine the user ID(s) recorded in the subscription list of the subscription information from the obtained subscription information configured for the target data packet.

In some embodiments, when determining the user ID(s) recorded in the subscription information according to the subscription information, the data processing apparatus may detect whether the number of user ID(s) recorded in the subscription list of the subscription information is equal to zero. If it is not equal to zero, the user ID(s) recorded in the subscription list of the subscription information can be determined according to the subscription information.

At S203, the target data packet is pushed according to the determined user ID(s). The data processing apparatus may push the target data packet to the requesting apparatus(es) indicated by the user ID(s) according to the user ID(s) determined in the subscription information.

In some embodiments, the subscription information configured for the target data packet can further include the task-pushed-times threshold. Before pushing the target data packet to the requesting apparatus(es) indicated by the user ID(s), the data processing apparatus may detect whether the number of times the target data packet has been pushed is less than the task-pushed-times threshold. If the detection result is “less than,” the data processing apparatus may push the target data packet to the requesting apparatus(es) indicated by the user ID(s) sequentially according to the user ID(s) determined from the subscription list of the subscription information and the order of the user ID(s) in the subscription list.

In some embodiments, the routing information can be bounded to the user ID. The data processing apparatus may obtain the user ID(s) from the subscription information, and obtain the routing information bounded to the user ID(s). According to the routing information, the data processing apparatus can determine the physical port(s) corresponding to the routing information and push the target data packet to the requesting apparatus(es) indicated by the user ID(s) through the physical port(s) corresponding to the routing information.

In some embodiments, the data processing apparatus can include the pushed-ID counter for counting the number of user IDs to which the target data packet has been pushed. When pushing the target data packet, the data processing apparatus may determine the target user ID from the determined user ID(s), and push the target data packet to the requesting apparatus corresponding to the target user ID. When pushing the target data packet according to the target user ID, each time the target data packet is pushed to the requesting apparatus corresponding to the target user ID, the count number of the pushed-ID counter can be increased by one. Before pushing the target data packet, the data processing apparatus may initialize the count number in the pushed-ID counter to zero. For example, assume that the user IDs determined, according to the subscription information, by the data processing apparatus in the subscription list of the subscription information are 1, 2, 3 in the time sequence. The data processing apparatus may determine that the target user ID is user ID 1 from the user IDs in the subscription list of the subscription information, and hence, push the target data packet to the requesting apparatus indicated by user ID 1 and increase the count number in the pushed-ID counter by 1. The data processing apparatus may then determine that the target user ID is user ID 2 from the user IDs in the subscription list of the subscription information, and hence, push the target data packet to the requesting apparatus indicated by user ID 2 and increase the count number in the pushed-ID counter by 1, thereby cumulatively increasing the count number in the pushed-ID counter to 2. The data processing apparatus may determine that the target user ID is user ID 3 from the user IDs in the subscription list of the subscription information, and hence, push the target data packet to the requesting apparatus indicated by user ID 3 and increase the count number in the pushed-ID counter by 1, thereby cumulatively increasing the count number in the pushed-ID counter to 3.

In some embodiments, after pushing the target data packet according to the determined user ID(s), the data processing apparatus may detect whether the number of user IDs, to which the target data packet has been pushed, recorded in the pushed-ID counter is equal to the number of user IDs recorded in the subscription information and, if the detect result is “not equal to” or “no,” determine that the user ID(s) recorded in the subscription information according to the subscription information can be triggered again after delaying for the preset time interval. For example, assume that the preset time interval set by the data processing apparatus is 2 s, and the user IDs in the subscription list of the subscription information are 1, 2, 3 in order. If the data processing apparatus pushes the target data packet according to the determined user ID 1 and detects that the number of user IDs, to which the target data packet has been pushed, recorded in the pushed-ID counter is not equal to the number of user IDs recorded in the subscription information, the data processing apparatus can trigger again to determine that user ID 2 is recorded after user ID 1 in the subscription information according to the subscription information after the delay of 2 s (i.e., the preset time interval) and send the target data packet to the requesting apparatus indicated by user ID2. The processes described above can be repeated in sequence, and the data processing apparatus can further send the target data packet to the requesting apparatus indicated by user ID3.

In some embodiments, the data processing apparatus may detect whether the number of times the target data packet has been pushed that is recorded by the pushed-ID counter equals the number of the user IDs in the subscription information. If the detect result is that the number of times the target data packet has been pushed that is recorded by the pushed-ID counter equals the number of the user IDs in the subscription information (e.g., the detect result is “equal to” or “yes”), the data processing apparatus can stop pushing the target data packet. For example, assume that the number of user IDs recorded in the subscription information is 3. If the number of times the target data packet has been pushed that is recorded by the pushed-ID counter is 3, it is determined that the counter number recorded by the pushed-ID counter equals the number of the user IDs in the subscription information, and hence, the data processing apparatus can stop pushing the target data packet.

Consistent with the disclosure, the data processing apparatus may obtain the subscription information configured for the target data packet in response to detecting that the target data packet needs to be sent. The user ID(s) recorded in the subscription information can be determine according to the subscription information, and the target data packet can be pushed according to the determined the user ID(s). As such, it is compatible with the different data push needs, the communication load of the system can be effectively balanced, and the system stability can be improved.

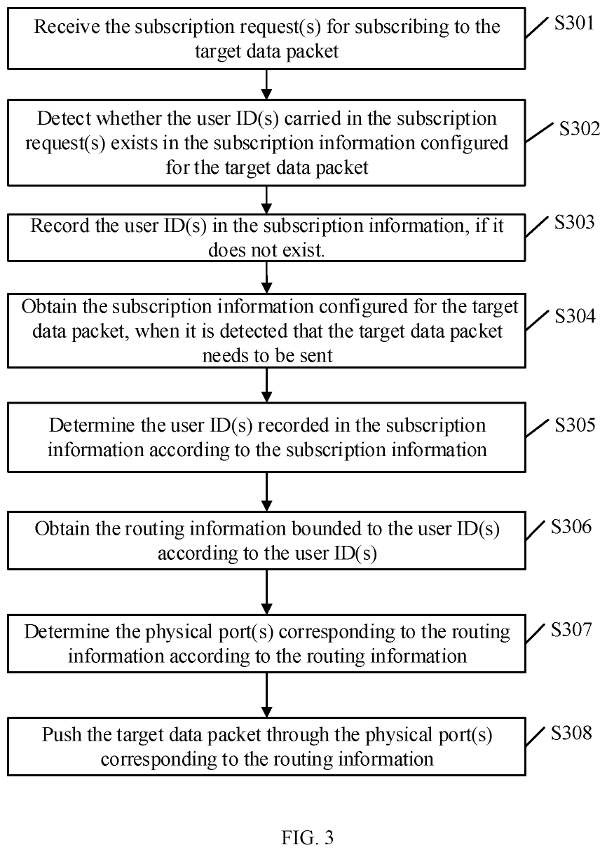

FIG. 3 is a schematic flow chart of another example data processing method consistent with the disclosure. The method can be applied to a data processing apparatus, for example, the data processing apparatus described above. Different from the method in FIG. 2, the data processing apparatus can detect whether the user ID(s) carried in the subscription request(s) exists in the subscription information configured for the target data packet through receiving the subscription request(s) for subscribing to the target data packet, and if not exists, the user ID(s) can be recorded in the subscription information.

As shown in FIG. 3, at S301, the subscription request(s) for subscribing to the target data packet is received. The data processing apparatus can receive the subscription request(s) for subscribing to the target data packet. The subscription request can carry the user ID(s) of the requesting apparatus(es) requesting the target data packet.

At S302, whether the user ID(s) carried in the subscription request(s) exists in the subscription information configured for the target data packet is detected. After receiving the subscription request(s) for subscribing to the target data packet, the data processing apparatus may detect whether the user ID(s) carried in the subscription request(s) exists in the subscription information configured for the target data packet. The subscription list in the subscription information can store the user ID(s) of the requesting apparatus(es) requesting to subscribe to the target data packet.

At S303, if the user ID(s) carried in the subscription request(s) does not exist in the subscription information configured for the target data packet, the user ID(s) is recorded in the subscription information. If detecting that the user ID(s) carried in the subscription request(s) does not exist in the subscription information configured for the target data packet, the data processing apparatus may record the received user ID(s) for requesting to subscribe to the target data packet in the subscription list of the subscription information.

In some embodiments, when recording the user ID(s) in the subscription information configured for the target data packet, the data processing apparatus may obtain the time information of each received subscription request for subscribing to the target data packet, and record the user ID determined from each subscription request in the subscription information configured for the target data packet according to the time sequence. For example, assume that the data processing apparatus receives the subscription requests sent by three requesting apparatuses for subscribing to the target data packet. When receiving the subscription requests, the data processing apparatus may obtain that the time for receiving the subscription request from the first requesting apparatus is 9:00, the time for receiving the subscription request from the second requesting apparatus is 9:05, and the time for receiving the subscription request from the third requesting apparatus is 9:10. According to the time sequence of the subscription requests of the requesting apparatuses, the data processing apparatus may sequentially record user ID 1 determined from the subscription request of the first requesting apparatus, user ID 2 determined from the subscription request of the second requesting apparatus, and user ID 3 determined from the subscription request of the third requesting apparatus into the subscription information configured for the target data packet.

At S304, when it is detected that the target data packet needs to be sent, the subscription information configured for the target data packet is obtained. When detecting that the target data packet needs to be sent, the data processing apparatus may obtain the subscription information configured for the target data packet.

At S305, the user ID(s) recorded in the subscription information is determined according to the subscription information. After detecting that the target data packet needs to be sent, the data processing apparatus may determine the user ID(s) recorded in the subscription list of the subscription information according to the obtained subscription information configured for the target data packet. For example, assume that the user IDs recorded in the subscription list of the subscription information are user ID 1, user ID 3, and user ID 2. If detecting that the target data packet needs to be sent, the data processing apparatus may determine the user IDs recorded in the subscription list of the subscription information as user ID 1, user ID 3, and user ID 2 according to the obtained subscription information configured for the target data packet.

At S306, the routing information bounded to the user ID(s) is obtained according to the user ID(s). After determining the user ID(s) recorded in the subscription information, the data processing apparatus may obtain the routing information bounded to the user ID(s) according to the user ID(s).

At S307, the physical port(s) corresponding to the routing information is determined according to the routing information. The data processing apparatus may determine the physical port(s) corresponding to the routing information according to the routing information bounded to the user ID(s) determined in the subscription information. For example, assume that the user IDs recorded in the subscription information are user ID 1, user ID 3, and user ID 2. The data processing apparatus may determine the physical port corresponding to the routing information bounded to user ID 1 to be, e.g., physical port 1, according to the routing information bounded to user ID 1, the physical port corresponding to the routing information bounded to user ID 3 to be, e.g., physical port 3, according to the routing information bounded to user ID 3, and the physical port corresponding to the routing information bounded to user ID 2 to be, e.g., physical port 2, according to the routing information bounded to user ID 2.

At S308, the target data packet is pushed through the physical port(s) corresponding to the routing information. The data processing apparatus may push the target data packet to the requesting apparatus(es) indicated by the user ID(s) through the physical port(s) corresponding to the routing information. For example, assume that the user IDs in the subscription information are user ID 1, user ID 3, user ID 2, and the physical port corresponding to the routing information bounded to user ID 1 is physical port 1, and the physical port corresponding to the routing information bounded to user ID 3 is physical port 3, and the physical port corresponding to the routing information bounded to user ID 2 is physical port 2. If detecting that the target data packet needs to be sent, the data processing apparatus may use physical port 1 corresponding to the routing information bounded to user ID 1 to push the target data packet to the requesting apparatus indicated by user ID 1, use physical port 3 corresponding to the routing information bounded to user ID 3 to push the target data packet to the requesting apparatus indicated by user ID 3, and use physical port 2 corresponding to the routing information bounded to user ID 2 to push the target data packet to the requesting apparatus indicated by user ID 2.

In some embodiments, the subscription information configured for the target data packet can further include the task-pushed-times threshold. Before pushing the target data packet to the requesting apparatus(es) indicated by the user ID(s), the data processing apparatus may detect whether the number of times the target data packet has been pushed is less than the task-pushed-times threshold. If the detection result is “less than,” the data processing apparatus may push the target data packet to the requesting apparatus(es) indicated by the user ID(s).

In some embodiments, the data processing apparatus can include the pushed-ID counter for counting the number of user IDs to which the target data packet has been pushed. When pushing the target data packet, the data processing apparatus may determine the target user ID from the determined user ID(s), and push the target data packet to the requesting apparatus corresponding to the target user ID. When pushing the target data packet according to the target user ID, the count number of the pushed-ID counter can be increased by one. Before pushing the target data packet, the data processing apparatus may initialize the count number in the pushed-ID counter to zero. For example, assume that the user IDs determined, according to the subscription information, by the data processing apparatus in the subscription list of the subscription information are 1, 2, 3 in the time sequence. The data processing apparatus may determine that the target user ID is user ID 1 from the user IDs in the subscription list of the subscription information, and hence, push the target data packet to the requesting apparatus indicated by user ID 1 and increase the count number in the pushed-ID counter by 1. The data processing apparatus may then determine that the target user ID is user ID 2 from the user IDs in the subscription list of the subscription information, and hence, push the target data packet to the requesting apparatus indicated by user ID 2 and increase the count number in the pushed-ID counter by 1, thereby cumulatively increasing the count in the pushed-ID counter to 2. The data processing apparatus may determine that the target user ID is user ID 3 from the user IDs in the subscription list of the subscription information, and hence, push the target data packet to the requesting apparatus indicated by user ID 3 and increase the count number in the pushed-ID counter by 1, thereby cumulatively increasing the count number in the pushed-ID counter to 3.

In some embodiments, after pushing the target data packet according to the determined user ID(s), the data processing apparatus may detect whether the number of user IDs, to which the target data packet has been pushed, recorded in the pushed-ID counter is equal to the number of user IDs recorded in the subscription information and, if the detect result is “not equal to,” determine the user ID(s) recorded in the subscription information according to the subscription information can be triggered again after delaying for the preset time interval. For example, assume that the preset time interval set by the data processing apparatus is 2 s, and the user IDs in the subscription list of the subscription information are 1, 2, 3 in order. If the data processing apparatus pushes the target data packet according to the determined user ID 1 and detects that the number of user IDs, to which the target data packet has been pushed, recorded in the pushed-ID counter is not equal to the number of user IDs recorded in the subscription information, the data processing apparatus can trigger again to determine that user ID 2 is recorded after user ID 1 in the subscription information according to the subscription information after the delay of 2 s (i.e., the preset time interval) and send the target data packet to the requesting apparatus indicated by user ID2. The processes described above can be repeated in sequence, and the data processing apparatus can further send the target data packet to the requesting apparatus indicated by user ID3.

In some embodiments, the data processing apparatus may detect whether the number of times the target data packet has been pushed that is recorded by the pushed-ID counter equals the number of the user IDs in the subscription information. If the detect result is “equal to,” the data processing apparatus can stop pushing the target data packet. For example, assume that the number of user IDs recorded in the subscription information is 3. If the data processing apparatus detects that the number of times the target data packet has been pushed that is recorded by the pushed-ID counter is 3, it is determined that the count number recorded by the pushed-ID counter equals the number of the user IDs in the subscription information, and hence, the data processing apparatus can stop pushing the target data packet.

Consistent with the disclosure, the data processing apparatus can receive the subscription request(s) for subscribing to the target data packet. If detecting that the user ID(s) carried in the subscription request(s) does not exist in the subscription information configured for the target data packet, the data processing apparatus can record the user ID(s) in the subscription information. When detecting that the target data packet needs to be sent, the data processing apparatus can obtain the subscription information configured for the target data packet, and determine the user ID(s) recorded in the subscription information according to the subscription information. Therefore, the target data packet can be pushed according to the determined user ID(s). As such, it can be compatible with different data push needs, the communication load of the system can be effectively balanced, and the system stability can be improved.

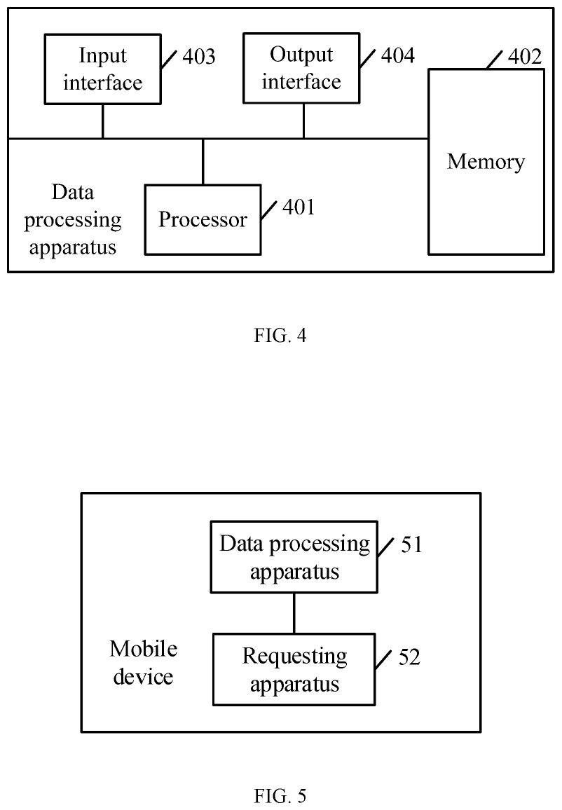

FIG. 4 is a schematic structural diagram of an example data processing apparatus consistent with the disclosure. As shown in FIG. 4, the data processing apparatus includes a memory 401, a processor 402, an input interface 403, and an output interface 404.

The memory 401 may include a volatile memory, a non-volatile memory, or any combination of thereof. The processor 402 may include a central processing unit (CPU). The processor 402 may further include a hardware chip. The hardware chip may include an application-specific integrated circuit (ASIC), a programmable logic device (PLD), or any combination thereof. The PLD may include a complex programmable logic device (CPLD), a field-programmable gate array (FPGA), or any combination thereof.

In some embodiments, the memory 401 can be configured to store program instructions. The processor 402 may call program instructions stored in the memory 401 to obtain the subscription information configured for the target data packet in response to detecting that the target data packet needs to be sent, determine the user ID(s) recorded in the subscription information according to the subscription information, and push the target data packet according to the determined user ID(s).

The processor 402 can be further configured to receive the subscription request(s) for subscribing to the target data packet, determine the user ID(s) from the subscription request(s), and record the user ID(s) in the subscription information configured for the target data packet. Each subscription request can carry the corresponding user ID.

The processor 402 can be further configured to detect whether the user ID(s) exists in the subscription information, and record the user ID(s) in the subscription information configured for the target data packet, in response to the detecting result being “no”.

The processor 402 can be further configured to obtain the time information of each received subscription request for subscribing to the target data packet, and record the user ID determined from each subscription request in the subscription information configured for the target data packet according to the time sequence.

The processor 402 can be further configured to detect whether the number of times the target data packet has been pushed is less than the task-pushed-times threshold, and push the target data packet according to the determined user ID(s) in response to the detection result being “yes”.

The processor 402 can be further configured to obtain the routing information bounded to the user ID(s) according to the user ID(s), determine the physical port(s) corresponding to the routing information according to the routing information, and push the target data packet through the physical port(s) corresponding to the routing information.

The processor 402 can be further configured to detect whether the number of user ID(s) recorded in the subscription information is equal to zero, and determine the user ID(s) recorded in the subscription information according to the subscription information, in response to the detecting result being “no”.

The processor 402 can be further configured to determine the target user ID from the user ID(s), push the target data packet according to the determined target user ID, and increase the count number of the pushed-ID counter by one in response to pushing the target data packet according to the target user ID.

The processor 402 can be further configured to detect whether the number of user IDs, to which the target data packet has been pushed, recorded in the pushed-ID counter is equal to the number of user IDs recorded in the subscription information, and trigger to determine the user ID(s) recorded in the subscription information according to the subscription information again after delaying for the preset time interval, in response to the detect result being “no”.

The processor 402 can be further configured to stop pushing the target data packet, in response to the count number of the pushed-ID counter being equal to the number of user IDs recorded in the subscription information.

In some embodiments, the data processing apparatus can be arranged at a smart gimbal and/or a UAV.

Consistent with the disclosure, the data processing apparatus may obtain the subscription information configured for the target data packet in response to detecting that the target data packet needs to be sent. The user ID(s) recorded in the subscription information can be determined according to the subscription information, and the target data packet can be pushed according to the determined the user ID(s). As such, it can be compatible with different data push needs, the communication load of the system can be effectively balanced, and the system stability can be improved.

FIG. 5 is a schematic structural diagram of an example mobile device consistent with the disclosure. As shown in FIG. 5, the mobile device includes a data processing apparatus 51 and one or more requesting apparatus 52.

The data processing apparatus 51 can be configured to obtain the subscription information configured for the target data packet in response to detecting that the target data packet needs to be sent, determine the user ID(s) recorded in the subscription information according to the subscription information, and push the target data packet according to the determined user ID(s).

The requesting apparatus(es) 52 is configured to send the subscription request(s) for subscribing to the target data packet to the data processing apparatus 51. The requesting apparatus(es) 52 can be a part of the mobile device or include other apparatuses connected to the mobile device.

In some embodiments, the mobile device can include a smart gimbal and/or a UAV.

The data processing apparatus 51 can be further configured to receive the subscription request(s) for subscribing to the target data packet, determine the user ID(s) from the subscription request(s), and record the user ID(s) in the subscription information configured for the target data packet. The subscription request can carry the user ID.

The data processing apparatus 51 can be further configured to detect whether the user ID(s) exists in the subscription information, and record the user ID(s) in the subscription information configured for the target data packet, in response to the detecting result being “no”.

The data processing apparatus 51 can be further configured to obtain the time information of each received subscription request for subscribing to the target data packet, and record the user ID determined from each subscription request in the subscription information configured for the target data packet according to the time sequence.

The data processing apparatus 51 can be further configured to detect whether the number of times the target data packet has been pushed is less than the task-pushed-times threshold, and push the target data packet according to the determined user ID(s) in response to the detection result being “yes”.

The data processing apparatus 51 can be further configured to obtain the routing information bounded to the user ID(s) according to the user ID(s), determine the physical port(s) corresponding to the routing information according to the routing information, and push the target data packet through the physical port(s) corresponding to the routing information.

The data processing apparatus 51 can be further configured to detect whether the number of user ID(s) recorded in the subscription information is equal to zero, and determine the user ID(s) recorded in the subscription information according to the subscription information, in response to the detecting result being “no”.

The data processing apparatus 51 can be further configured to determine the target user ID from the user ID(s), push the target data packet according to the determined target user ID, and increase the count number of the pushed-ID counter by one in response to pushing the target data packet according to the target user ID.

The data processing apparatus 51 can be further configured to detect whether the number of user IDs, to which the target data packet has been pushed, recorded in the pushed-ID counter is equal to the number of user IDs recorded in the subscription information, and trigger to determine the user ID(s) recorded in the subscription information according to the subscription information again after delaying for the preset time interval, in response to the detect result being “no”.

The data processing apparatus 51 can be further configured to stop pushing the target data packet, in response to the count number of the pushed-ID counter being equal to the number of user IDs recorded in the subscription information.

Consistent with the disclosure, the data processing apparatus 51 may obtain the subscription information configured for the target data packet when detecting that the target data packet needs to be sent. The user ID(s) recorded in the subscription information can be determined according to the subscription information, and the target data packet can be pushed to the requesting apparatus(es) 52 according to the determined the user ID(s). As such, it can be compatible with different data push needs, the communication load of the system can be effectively balanced, and the system stability can be improved.

The present disclosure further provides an example data processing system including the data processing apparatus and the requesting apparatus(es). The requesting apparatus(es) can be configured to send the subscription request(s) for subscribing to the target data packet to the data processing apparatus.

The data processing apparatus can be configured to obtain the subscription information configured for the target data packet in response to detecting that the target data packet needs to be sent, determine the user ID(s) recorded in the subscription information according to the subscription information, and push the target data packet according to the determined user ID(s).

The data processing apparatus can be further configured to receive the subscription request(s) for subscribing to the target data packet, determine the user ID(s) from the subscription request(s), and record the user ID(s) in the subscription information configured for the target data packet. The subscription request can carry the user ID.

The data processing apparatus can be further configured to detect whether the user ID(s) exists in the subscription information, and record the user ID(s) in the subscription information configured for the target data packet, in response to the detecting result being “no”.

The data processing apparatus can be further configured to obtain the time information of each received subscription request for subscribing to the target data packet, and record the user ID determined from each subscription request in the subscription information configured for the target data packet according to the sequence of the time information.

The data processing apparatus can be further configured to detect whether the number of times the target data packet has been pushed is less than the task-pushed-times threshold, and push the target data packet according to the determined user ID(s) in response to the detection result being “yes”.

The data processing apparatus can be further configured to obtain the routing information bounded to the user ID(s) according to the user ID(s), determine the physical port(s) corresponding to the routing information according to the routing information, and push the target data packet through the physical port(s) corresponding to the routing information.

The data processing apparatus can be further configured to detect whether the number of user ID(s) recorded in the subscription information is equal to zero, and determine the user ID(s) recorded in the subscription information according to the subscription information, in response to the detecting result being “no”.

The data processing apparatus can be further configured to determine the target user ID from the user ID(s), push the target data packet according to the determined target user ID, and increase the count number of the pushed-ID counter by one when pushing the target data packet according to the target user ID.

The data processing apparatus can be further configured to detect whether the number of user IDs, to which the target data packet has been pushed, recorded in the pushed-ID counter is equal to the number of user IDs recorded in the subscription information, and trigger to determine the user ID(s) recorded in the subscription information according to the subscription information again after delaying for the preset time interval, in response to the detect result being “no”.

The data processing apparatus can be further configured to stop pushing the target data packet, in response to the count number of the pushed-ID counter being equal to the number of user IDs recorded in the subscription information.

In some embodiments, the data processing apparatus can be arranged at a smart gimbal and/or a UAV.

Consistent with the disclosure, the data processing apparatus may obtain the subscription information configured for the target data packet when detecting that the target data packet needs to be sent. The user ID(s) recorded in the subscription information can be determine according to the subscription information, and the target data packet can be pushed according to the determined the user ID(s). As such, it can be compatible with different data push needs, the communication load of the system can be effectively balanced, and the system stability can be improved.

The present disclosure further provides an example computer-readable storage medium. The computer-readable storage medium can store a computer program, and when the computer program is executed by a processor, the data processing method in FIG. 1, 2, or 3 can be implemented and the data processing apparatus in FIG. 4 can be realized, and detailed description thereof will be omitted here.

The computer-readable storage medium may include an internal storage unit of the apparatus described in any of the foregoing embodiments, such as a hard disk or a memory of the apparatus. The computer-readable storage medium may include an external storage device of the apparatus, such as a plug-in hard disk equipped on the device, a smart media card (SMC), and a secure digital (SD) card, a flash card, and/or the like. The computer-readable storage medium may include both the internal storage unit of the apparatus and the external storage device. The computer-readable storage medium can be configured to store the computer program and other programs and data required by the terminal. The computer-readable storage medium may be further configured to temporarily store data that has been or will be output.

Some or all of the processes of the method described above can be executed by hardware running program instructions. The program may be stored in a computer-readable storage medium. When the program is executed, the processes of the method are executed. The computer-readable storage medium can include a read-only memory (ROM), a random-access memory (RAM), a magnetic disk, an optical disk, or another medium that can store program codes.

It is intended that the disclosed embodiments be considered as exemplary only and not to limit the scope of the disclosure. Changes, modifications, alterations, and variations of the above-described embodiments may be made by those skilled in the art within the scope of the disclosure.

What is claimed is:

1. A data processing method comprising:
in response to detecting that a target data packet needs to be sent, obtaining subscription information configured for the target data packet;
determining one or more user identifications (IDs) recorded in the subscription information according to the subscription information; and
pushing the target data packet according to the one or more user IDs.

2. The method of claim 1, further comprising, before obtaining the subscription information:
receiving one or more subscription requests for subscribing to the target data packet, each of the one or more subscription requests carrying a requesting user ID;
determining the requesting user ID from each of the one or more subscription requests to obtain one or more determined user IDs; and
recording the one or more determined user IDs in the subscription information.

3. The method of claim 2, wherein recording the one or more determined user IDs in the subscription information includes:
detecting whether the one or more determined user IDs exist in the subscription information; and
in response to detecting one or more non-existing user IDs from the one or more determined user IDs:
obtaining time information of each subscription request that corresponds to one of the one or more non-existing user IDs; and
recording the non-existing user IDs in the subscription information according to a time sequence determined based on the time information.

4. The method of claim 1, wherein:
the subscription information includes a task-pushed-times threshold; and
the method further comprising, before pushing the target data packet:
detecting whether a number of packet-pushed times is less than the task-pushed-times threshold, the number of packet-pushed times indicating a number of times the target data packet has been pushed; and
pushing the target data packet according to the one or more user IDs in response to detecting that the number of packet-pushed times is less than the task-pushed-times threshold.

5. The method of claim 1, wherein:
each of the one or more user IDs is bound with routing information; and
pushing the target data packet includes:
obtaining the routing information bounded to one of the one or more user IDs;
determining a physical port corresponding to the routing information; and
pushing the target data packet through the physical port.

6. The method of claim 1, wherein determining the one or more user IDs includes:
detecting whether a number of user IDs recorded in the subscription information is equal to zero; and
determining the one or more user IDs recorded in the subscription information according to the subscription information in response to detecting that the number of user IDs recorded in the subscription information is not equal to zero.

7. The method of claim 1, wherein the target data packet is sent by a smart gimbal.

8. A data processing apparatus comprising:
a memory storing program instructions; and
a processor configured to call the program instructions to:
in response to detecting that a target data packet needs to be sent, obtain subscription information configured for the target data packet;
determine one or more user identifications (IDs) recorded in the subscription information according to the subscription information; and
push the target data packet according to the one or more user IDs.

9. The apparatus of claim 8, wherein the processor is further configured to call the program instructions to:
receive one or more subscription requests for subscribing to the target data packet, each of the one or more subscription requests carrying a requesting user ID;
determine the requesting user ID from each of the one or more subscription requests to obtain one or more determined user IDs; and
record the one or more determined user IDs in the subscription information.

10. The apparatus of claim 9, wherein the processor is further configured to call the program instructions to:
detect whether the one or more determined user IDs exist in the subscription information; and
in response to detecting one or more non-existing user IDs from the one or more determined user IDs, record the one or more non-existing user IDs in the subscription information.

11. The apparatus of claim 10, wherein the processor is further configured to call the program instructions to:
obtain time information of each subscription request that corresponds to one of the one or more non-existing user IDs; and
record the non-existing user IDs in the subscription information according to a time sequence determined based on the time information.

12. The apparatus of claim 8, wherein:
the subscription information includes a task-pushed-times threshold; and
the processor is further configured to call the program instructions to:
detect whether a number of packet-pushed times is less than the task-pushed-times threshold, the number of packet-pushed times indicating a number of times the target data packet has been pushed; and
push the target data packet according to the one or more user IDs in response to detecting that the number of packet-pushed times is less than the task-pushed-times threshold.

13. The apparatus of claim 8, wherein:
each of the one or more user IDs is bound with routing information; and
the processor is further configured to call the program instructions to:
obtain the routing information bounded to one of the one or more user IDs;
determine a physical port corresponding to the routing information; and
push the target data packet through the physical port.

14. The apparatus of claim 8, wherein the processor is further configured to call the program instructions to:
detect whether a number of user IDs recorded in the subscription information is equal to zero; and
determine the one or more user IDs recorded in the subscription information according to the subscription information in response to detecting that the number of user IDs recorded in the subscription information is not equal to zero.

15. The apparatus of claim 14, wherein the processor is further configured to call the program instructions to:
determine a target user ID from the one or more user IDs;
push the target data packet according to the target user ID; and
increase a count number of a pushed-ID counter by one in response to the target data packet being pushed according to the target user ID.

16. The apparatus of claim 15, wherein the processor is further configured to call the program instructions to:
detect whether a number of user IDs recorded in the pushed-ID counter is equal to the number of user IDs recorded in the subscription information; and
determine the one or more user IDs recorded in the subscription information according to the subscription information after delaying for a preset time interval, in response to detecting that the number of user IDs recorded in the pushed-ID counter is not equal to the number of user IDs recorded in the subscription information.

17. The apparatus of claim 16, wherein the processor is further configured to call the program instructions to:
stop pushing the target data packet in response to detecting that the number of user IDs recorded in the pushed-ID counter is equal to the number of user IDs recorded in the subscription information.

18. The apparatus of claim 8, wherein the apparatus is arranged at a smart gimbal and/or an unmanned aerial vehicle (UAV).

19. A mobile device comprising:
a data processing apparatus configured to:
in response to detecting that a target data packet needs to be sent, obtain subscription information configured for the target data packet;
determine one or more user identifications (IDs) recorded in the subscription information according to the subscription information; and
push the target data packet according to the one or more user IDs.

20. The device of claim 19, further comprising:
a requesting apparatus configured to send a subscription request for subscribing to the target data packet to the data processing apparatus;
wherein the device is a smart gimbal and/or an unmanned aerial vehicle (UAV).
